(19) United States
(12) Patent Application Publication
(10) Pub. No.: US 2007/0083609 A1
(43) Pub. Date: Apr. 12, 2007

(54) Steel bands

(76) Inventors: Barbara Diane Becker, Aurora, CO (US); Peter Ryan Elespuru, Broomfield, CO (US)

Correspondence Address: Barbara Diane Becker, 4251 S. Himalaya Way, Aurora, CO, 80013, US

(21) Appl. No.: 11/244,611

(22) Filed: Oct. 6, 2005

(51) Int. Cl. G06F 15/16

(52) U.S. Cl. 709/217

(57) ABSTRACT

This disclosure depicts the role of Steel Bands, its wireless protocol and topology in monitoring the human in mutation trends as organisms and units of change within populations under natural selection operating in geographic areas. The disclosures regarding drug, food, and alcohol addictions results in population statistics as applied to mass electrical phenocopies in geographic areas.

The parties listed above have full rights with no employment rights transmitted to any company and no federally sponsored or funded rights. To the best of our knowledge this Trademark, wireless protocol, and technology topology will be produced by a private investor.

### DESCRIPTION OF PRIOR ART

Prior state of data is entirely manual.

Steel Bands Capture Discussion

Each wearer (Steel Band) is assigned a unique number for further coordination. This number will be at least 16 digits long, and will be used to identify each individual wearer (Steel Band) for all further transactions. Each Steel Band will be programmed at the time of installation on the wearer with this unique number. Each wearer will be indexed in all databases via this number.

A system topology is necessary to facilitate storage, analyzing and statistics creation based on all of the captured data. The system topology can vary based on need and application, but a typical minimal infrastructure would contain 1 central server, 1 site server, and 1 or more site clients. The system can be scaled as much as is necessary for a given implementation. For instance, the number of servers (site and central) as well as clients is scalable as needed. All three nodes can be the same machine in the smallest installation.

The purpose of the central server is to store data from each site server, and to have analyses calculated upon its contents to provide statistics and reporting to interested parties. The purpose of the site server is to store the daily captures from each Steel Band wearer, and store it until it is retrieved by the central server. The purpose of the client is to provide a monitor (employee) to actually capture data from a Steel Band wearer. After acquiring a data dump, the client machine should send that data along to the site server for storage. The Steel Band itself contains any valid wireless technology to allow for connection and downlink of data to the client.

Example Setup and Scenario

1 Central Server—Corporate Location.
1 Site Server—Gym1 or Monitoring Site
1 Client at Gym1 or Monitoring Site.
Person A is a Steel Band wearer.
Person B is a “monitor” employee at Gym1 or Monitoring Site.

A comes into gym1 (or monitoring site) to workout and be monitored. After working out, A gets in line at the monitor station and waits for B to read his/her data for the day. B sits at the “client” computer, and has a list of nearby bracelet wearers while A is in front of the line waiting to be read. B selects A from a list of visible (based on aforementioned unique id) wearers, and initiates a data dump. This happens via whichever wireless protocol is being used for this particular installation (Bluetooth etc . . . ). Once B has down linked (dumped) A's data for the timeframe, the client computer captures it, and transfers it to the site server. This concludes the necessary involvement of A and B. On a daily basis, the central server obtains data from the site server. Once all new daily data is retrieved, it is analyzed carefully. Any statistics required are created from the data, and any appropriate people or jurisdictions are emailed based again on the unique user ID.

### BACKGROUND OF INVENTION

The background of the invention (Steel Bands) originates in the paradigm of dopamine receptors in the use of alcohol, drugs, and overuse of food.

### OBJECT OF INVENTION

The object is to monitor probation, parole offenders or any subset of addictions.

### DESCRIPTION OF INVENTION

There is no invention or mechanism, machine, or manufacture, which monitors probation and parole offenders in this manner other than incarceration. The invention incarcerates without incarceration.

### DESCRIPTION OF THE PREFERRED EMBODIMENT

Steel Bands will monitor drug, alcohol and food ingestion based on an implant reading the exact chemical structure of the ingested food or drug, in addiction to other programmed system monitoring for insulin, carbohydrates, liver enzyme P450, etc. and the microchips and/or wireless protocol will record the data and store it on a one day at a time basis downloading to the site server to be transmitted to the central server, probation, and appropriate parties based on id numbers lazer printed on the Steel Band. Each Steel Band is powered to transmit data from the implant to the Steel Band based on the wearer's electromagnetic field on a daily basis due to court ordered exercise. The purpose of this methodology is drug, drug alcohol, and food ingestion decreases the function of dopamine receptors in the human system and supplementation and exercise are the only method of reestablishing a normal dopamine receptor balance to the human system. Electromagnetic frequencies will establish population PML waves in geographic areas to record data in the reduction of addiction statistics and elected disease in areas.

1. What we claim as our invention is the understanding of the paradigm of dopamine receptors in the regulation of addiction as applied to the methodology of Steel Bands, the outlined wireless protocol, technology topology, and mechanism of Steel Bands for reading, recording, storing, and transmitting physiological and human organism information pertaining to addictions and varied diseases in geographic, national, and international areas as related to the use of exercise science and its regulation by the human technology.

2. What we claim as our invention is the methodology of claims 1, 2, and 3, Steel Bands, with the entire system applied to an alternate method of incarceration and method of treating addiction.
